(19) United States
(12) Patent Application Publication
(10) Pub. No.: US 2013/0265874 A1
(43) Pub. Date: Oct. 10, 2013

(54) LINK-AWARE APPLICATION SOURCE-RATE CONTROL TECHNIQUE

(71) Applicants: Jing Zhu, Portland, OR (US); Rath Vannithamby, Portland, OR (US); Shweta Shrivastava, Bangalore (IN)

(72) Inventors: Jing Zhu, Portland, OR (US); Rath Vannithamby, Portland, OR (US); Shweta Shrivastava, Bangalore (IN)

(21) Appl. No.: 13/995,050

(22) PCT Filed: Sep. 30, 2011
(86) PCT No.: PCT/US11/54224

§ 371 Date: Jun. 17, 2013

(51) Int. Cl. H04W 28/02

(52) U.S. Cl. CPC H04W 28/0289
USPC 370/232

(57) ABSTRACT

A system and method for adapting the source rate of a Voice-over-Internet-Protocol-type (VoIP-type) application. A MAC Layer device outputs information related to a congestion condition of a wireless link and information related to a Round Trip Time (RTT) of an end-to-end connection of the wireless link, the wireless link being for communicating data generated by an application operating on the device, and comprising a source rate of data generated by the application and a Packet Inter-arrival Time (PIT) for the data generated by the application. A rate controller determines a source rate of the application and/or the PIT based on the information related to the congestion condition of the wireless link and the information related to the RTT of the end-to-end connection of the wireless link.

### BACKGROUND

For conventional Voice-over-Internet-Protocol-type (VoIP-type) applications, such as Skype™, the VoIP-type application reduces its source rate whenever congestion is detected through an end-to-end measurement, such as Round Trip Time (RTT). It may not always be necessary, however, to reduce the source rate, particularly when the congestion occurs locally, because doing so significantly impacts voice quality and the detected congestion could be mitigated by increasing Packet Inter-arrival Time (PIT) alone.

### DESCRIPTION OF THE DRAWING FIGURES

Claimed subject matter is particularly pointed out and distinctly claimed in the concluding portion of the specification. Such subject matter may, however, be understood by reference to the following detailed description when read with the accompanying drawings in which:

FIG. 1 depicts an exemplary embodiment of a four-state system for performing source rate and PIT adaptation at the application layer according to the subject matter disclosed herein;

FIG. 2 shows an exemplary embodiment of a seven-state system for performing source rate and PIT adaptation at the application layer according to the subject matter disclosed herein;

FIG. 3 depicts a functional block diagram of an exemplary embodiment of a system for performing source rate and PIT adaptation at an application layer according to the subject matter disclosed herein;

FIG. 4 shows a block diagram of the overall architecture of a 3GPP LTE network including network elements and standardized interfaces;

FIGS. 5 and 6 depict radio interface protocol structures between a UE and an eNodeB that are based on a 3GPP-type radio access network standard;

FIG. 7 depicts functional block diagram of an information-handling system 700 that is capable of performing source rate and PIT adaptation at an application layer according to the subject matter disclosed herein; and

FIG. 8 depicts a functional block diagram of a wireless local area or cellular network communication system depicting one or more network devices that are capable of performing source rate and PIT adaptation at an application layer according to the subject matter disclosed herein.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. It will, however, be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. Coupled may, however, also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. “Over” may, however, also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other. As used herein, the word “exemplary” means “serving as an example, instance, or illustration.” Any embodiment described herein as “exemplary” is not to be construed as necessarily preferred or advantageous over other embodiments.

The subject matter disclosed herein provides a multi-state mechanism for individually adapting the source rate and Packet Inter-arrival Time (PIT), which provides a better voice quality in comparison to a conventional two-state adaptation. PIT is a parameter that is adjusted for packets arriving at the device, i.e., the near end of the link. In other words, for a given source rate, a longer PIT leads to a larger packet size for each packet. Additionally, the subject matter disclosed herein allows other MAC/linklayer information to be exposed to a Voice-over-Internet-Protocol-type (VoIP-type) application so that the application can adapt its source rate faster than a conventionally based adaptation that is based purely on an end-to-end measurement.

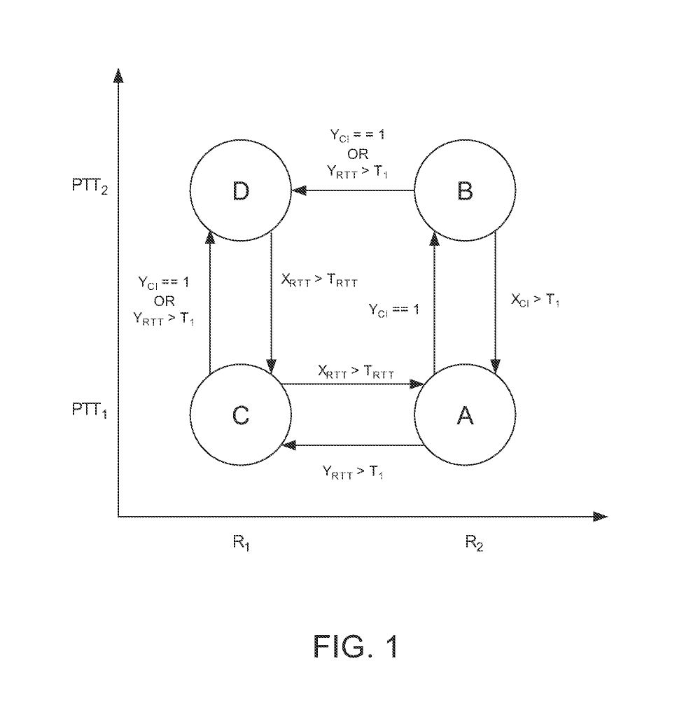

FIG. 1 depicts an exemplary embodiment of a four-state system for performing source rate and PIT adaptation at the application layer according to the subject matter disclosed herein. In particular, source rate and PIT adaptation is performed at the application layer, i.e., Skype™ based on the value of a Congestion Indicator (CI) of the wireless link and the value of a Round Trip Time (RTT) of the end-to-end connection. The Congestion Indicator (CI) provides an indication of a link-level condition, usually measured by the wireless device associated with the VoIP-type application. In one exemplary embodiment, if no congestion is detected, then the value of CI=0; and if congestion is detected, CI=1. Round Trip Time (RTT) is an indication of the end-to-end network condition, usually measured by the application.

For the four-state machine depicted in FIG. 1, there are two levels of source rate, i.e., R₁ and R₂, such that R₁<R₂, and two levels of PIT, i.e., PIT₁ and PIT₂, such that PIT₁<PIT₂. The four states of the machine of FIG. 1 are State A (R₂, PIT₁); State B (R₂, PIT₂); State C (R₁, PIT₁); and State D (R₁, PIT₂).

During operation of the machine, the latest measurement of CI and RTT are respectively defined to be Y_{CI} and Y_{RTT}. The variables X_{CI} and X_{RTT} are used to count the number of consecutive measurements for which CI=0 and RTT≦T₁, in which T₁ is a threshold to detect the end-to-end congestion. In one exemplary embodiment, T₁ may be set to 500 ms. Both the X_{CI} and X_{RTT} counters are reset to 0 whenever a new state is entered. Also, if CI=1 is detected, X_{CI} is reset to 0. Similarly, if RTT>T₁ is received, X_{RTT} is reset to 0. Two thresholds, T_{CI} and T_{RTT}, are respectively defined to increase the stability of the multi-state rate adaptation, and minimize state oscillation. In one exemplary embodiment, both thresholds are set to the value of 10.

The following conditions cause state transitions:

A→B: Y_{CI}==1

B→A: X_{CI}>T_{C1}

B→D: Y_{CI}==1 OR Y_{RTT}>T₁

A→C: Y_{RTT}>T₁

C→A: X_{RTT}>T_{RTT}

C→D: Y_{CI}==1 OR Y_{RTT}>T₁

D→C: X_{RTT}>T_{RTT}

During operation, CI and RTT may be updated periodically, i.e., every measurement cycle, such as once a second, or could be event driven, i.e., updated if there is a change in the either value such that the new value crosses a defined threshold. Accordingly, the respective measurement cycles for CI and RTT may be different.

If congestion occurs and if it is detected locally through the CI measurement, the adaptation path A→B→D is used so that the source rate remains unchanged. PIT is increased alone to attempt to mitigate the congestion before the source rate is changed. On the other hand, if congestion is detected through the end-to-end RTT measurement, the adaptation path: A→C→D is used, i.e., reducing the source rate first, and then increasing PIT if congestion is not mitigated. As congestion is mitigated, the return path from State D to State A used is D→C→A.

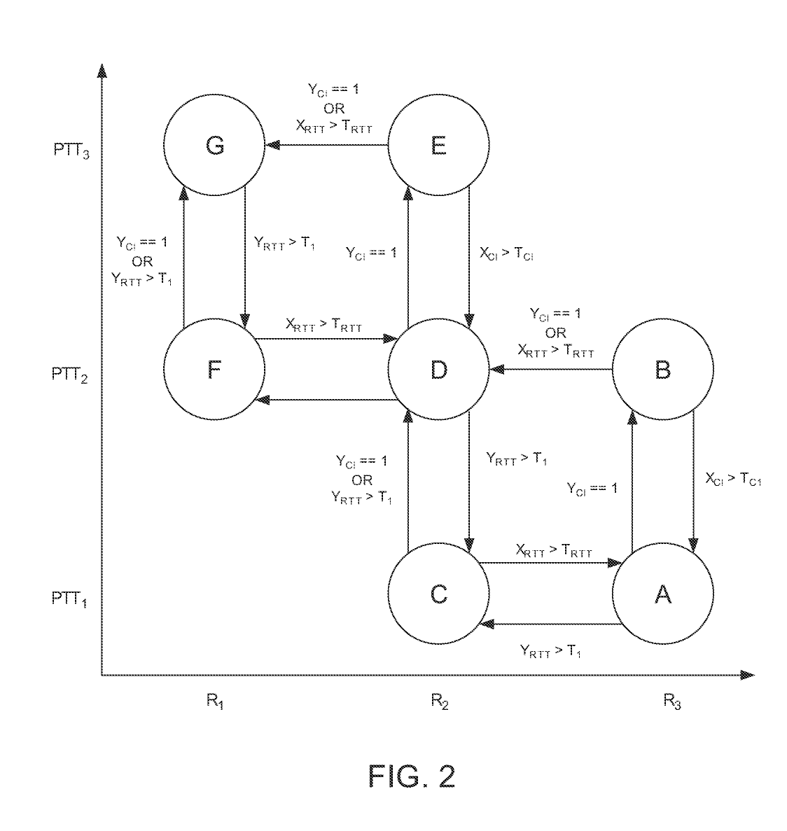

The technique disclosed herein for performing source rate and PIT adaptation at the application layer can be extended to support more than two source rates and more than two levels of PTT. For example, FIG. 2 shows an exemplary embodiment of a seven-state system for performing source rate and PIT adaptation at the application layer according to the subject matter disclosed herein.

For the seven-state machine depicted in FIG. 2, there are three levels of source rate, i.e., R₁, R₂ and R₃, such that R₁<R₂<R₃, and three levels of PIT, i.e., PIT₁, PIT₂ and PTT₃, such that PIT₁<PIT₂<PTT₃. The seven states of the machine of FIG. 2 are State A (R₃, PIT₁); State B (R₃, PIT₂); State C (R₂, PIT₁); State D (R₂, PIT₂); State E (R₂, PTT₃); State F (R₁, PTT₂); and State G (R₁, PTT₃).

Similar to the operation of the machine of FIG. 1, for the machine of FIG. 2 the latest measurement of CI and RTT are respectively defined to be Y_{CI} and Y_{RTT} and the variables X_{CI} and X_{RTT} are used to count the number of consecutive measurements for which CI=0 and RTT≦T₁, in which T₁ is a threshold to detect the end-to-end congestion. Again, in one exemplary embodiment, T₁ may be set to 500 ms. Both the X_{CI} and X_{RTT} counters are reset to 0 whenever a new state is entered. Also, if CI=1 is detected, X_{CI} is reset to 0. Similarly, if RTT>T₁ is received, X_{RTT} is reset to 0. Two thresholds, T_{CI} and T_{RTT}, are respectively defined to increase the stability of the multi-state rate adaptation, and minimize state oscillation. In one exemplary embodiment, both thresholds are set to the value of 10.

The following conditions cause state transitions:

A→B: Y_{CI}==1

B→A: X_{CI}>T_{C1}

B→D: Y_{CI}==1 OR Y_{RTT}>T₁

A→C: Y_{RTT}>T₁

C→A: X_{RTT}>T_{RTT}

C→D: Y_{CI}==1 OR Y_{RTT}>T₁

D→C: X_{RTT}>T_{RTT}

D→E: Y_{CI}==1

E→D: X_{CI}>T_{C1}

D→F: Y_{RTT}>T₁

F→D: X_{RTT}>T_{RTT}

F→G: Y_{RTT}>T₁

G→F: Y_{CI}==1 OR Y_{RTT}>T₁

During operation of the machine of FIG. 2, CI and RTT may be updated periodically, i.e., every measurement cycle, such as once a second, or could be event driven, i.e., updated if there is a change in the either value such that the new value crosses a defined threshold. Accordingly, the respective measurement cycles for CI and RTT may be different.

If congestion occurs while in State A and if it is detected locally through the CI measurement, the adaptation path A→B→D is used such that the source rate remains unchanged. PIT is increased alone to attempt to mitigate the congestion before the source rate is changed. On the other hand, if congestion is detected through the end-to-end RTT measurement while in State A, the adaptation path: A→C→D is used, i.e., reducing the source rate first, and then increasing PIT if congestion is not mitigated. As congestion is mitigated, the return path from State D to State A used is D→C→A.

If congestion occurs while in State D and if it is detected locally through the CI measurement, the adaptation path D→E→G is used such that the source rate remains unchanged. PIT is increased alone to attempt to mitigate the congestion before the source rate is changed. On the other hand, if congestion is detected through the end-to-end RTT measurement while in State D, the adaptation path: D→F→G is used, i.e., reducing the source rate first, and then increasing PIT if congestion is not mitigated. As congestion is mitigated, the return path from State G to State D used is G→F→D.

According to the subject matter disclosed herein, other MAC and Link Layer Information (MAC Layer Information) that can be used by for performing source rate and PIT adaptation at the application layer according to the subject matter disclosed herein includes channel quality (CQI) feedback information; geometry information; base station (BS) sector loading information; and UL transmit buffer-level status.

CQI feedback information provides information about the channel variation as seen by a wireless device. Generally, a high CQI value implies a good channel condition and the application source rate can be kept to a reasonably high value to achieve a required QoS. On the other hand, a low CQI value implies adverse channel condition. By knowing that CQI is a low value, the application can limit its source rate to a minimal value to avoid buffer overflow at the uplink transmit buffer, thereby avoiding congestion. That is, if buffer overflow occurs, packets will be discarded. If the source rate is adapted based on CQI, potential packet drops can be avoided. This will not only avoid buffer overflow/packet drop, but also avoids service interruption at the wireless device end.

Similar to CQI feedback information, geometry information provides information about the average channel that depends on how far a wireless device is from the serving and an interfering BS. If the wireless device is far from the serving BS, application source rate of the wireless device can be limited to avoid buffer overflow/packet drop. BS sector loading provides information about how much load in its serving BS. If the BS is heavily loaded, the application source rate can be limited to a minimal value to avoid buffer overflow/packet drop at a wireless device because the BS will likely limit its service rate due to high loading. Transmit buffer-level status can indicate of any potential current/future overflow or packet drop due to congestion. By knowing this information, the application can do rate adaptation to avoid packet drop when get into congestion while get good quality when not in congestion.

All these information are not conventionally available at the application layer. By making one or more of these MAC Layer information available at the application layer, the source rate can be adapted much quicker and more intelligently than that would be possible based on a mere end-to-end measurement. If source-rate adaptation is slow (as may be the case with conventional source-rate adaptation), by the time the conventional rate adaptation is attempted, buffer overflow/congestion could have already happened.

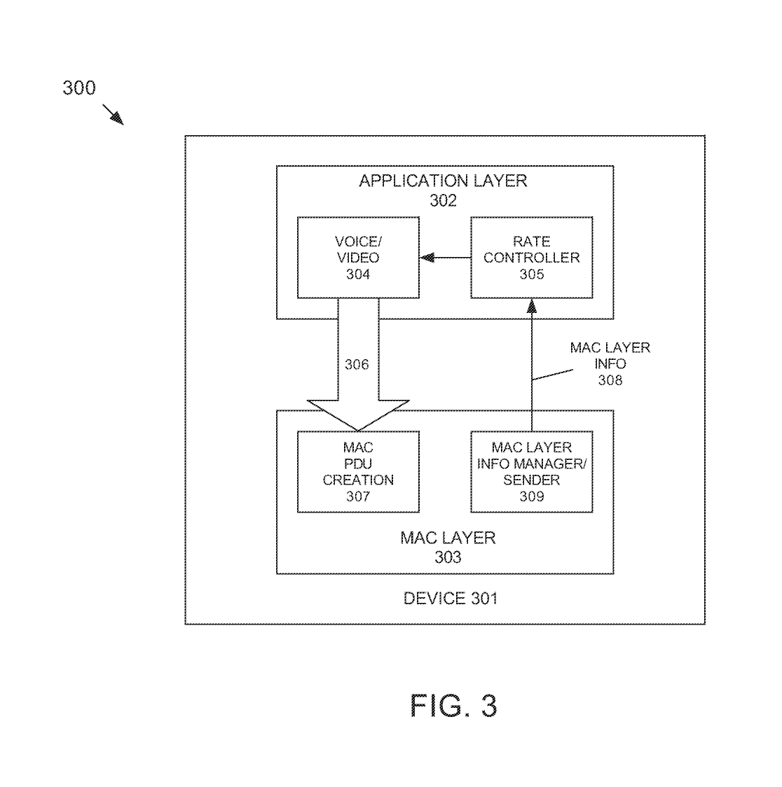

FIG. 3 depicts a functional block diagram of an exemplary embodiment of a system 300 for performing source rate and PIT adaptation at an application layer according to the subject matter disclosed herein. System 300 comprises an application layer 302 and a MAC layer 303 within a device 301. Application layer 302 comprises a voice/video functional block 304 and a rate controller 305. Voice/video functional block 304 outputs voice/video data 306 to MAC Protocol Data Unit (PDU) creation block 307. Rate controller 305 receives MAC layer information 308 from MAC Layer Information Manager/Sender block 309. MAC Layer Info Manager/Sender 309 makes the MAC layer info available to rate controller 305 in application layer 302. Rate controller 305 uses the MAC Layer information and performs intelligent source rate control according to the subject matter disclosed herein to avoid buffer overflow/packet drop, thereby providing the best application quality possible. The MAC Layer information can be periodically updated and communicated to application layer 302 or could be updated in an event-driven manner, thereby reducing the amount overhead associated with MAC layer information sharing. In one exemplary embodiment, the update is triggered only if a threshold associated with monitored MAC Layer information is crossed.

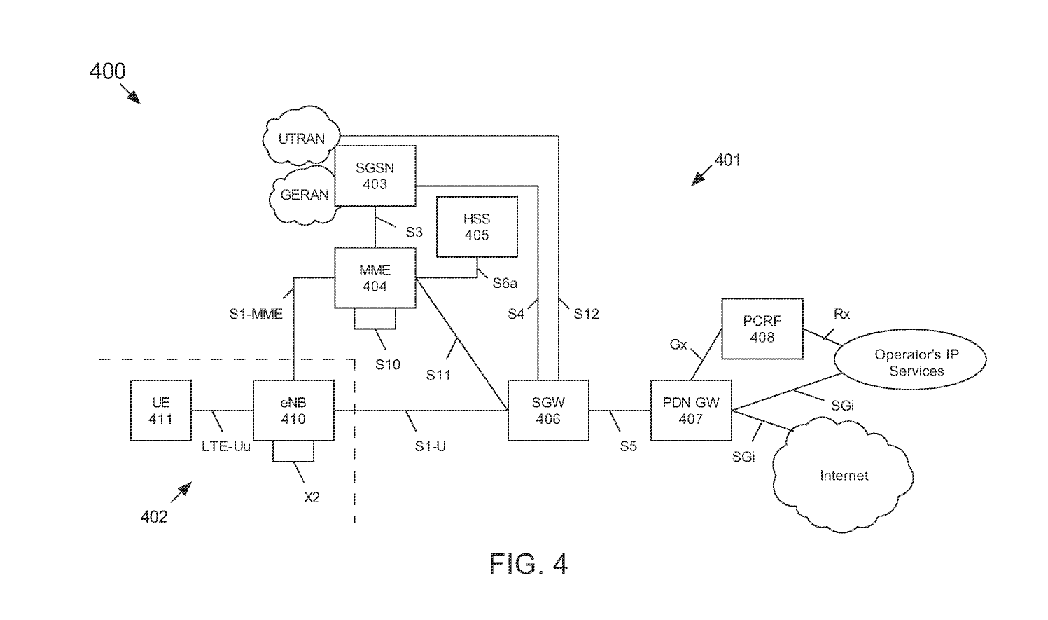

FIG. 4 shows a block diagram of the overall architecture of a 3GPP LTE network 400 that includes network elements and standardized interfaces. At a high level, network 400 comprises a core network (CN) 401 (also referred to as the evolved Packet System (EPC)), and an air-interface access network E-UTRAN 402. CN 401 is responsible for the overall control of the various User Equipment (UE) connected to the network and establishment of the bearers. E-UTRAN 402 is responsible for all radio-related functions.

The main logical nodes of CN 401 include a Serving GPRS Support Node 403, the Mobility Management Entity 404, a Home Subscriber Server (HSS) 405, a Serving Gate (SGW) 406, a PDN Gateway 407 and a Policy and Charging Rules Function (PCRF) Manager 408. The functionality of each of the network elements of CN 401 is well known and is not described herein. Each of the network elements of CN 401 are interconnected by well-known standardized interfaces, some of which are indicated in FIG. 4, such as interfaces S3, S4, S5, etc., although not described herein.

While CN 401 includes many logical nodes, the E-UTRAN access network 402 is formed by one node, the evolved NodeB (eNB) 410, which connects to one or more User Equipment (UE) 411, of which only one is depicted in FIG. 4. For normal user traffic (as opposed to broadcast), there is no centralized controller in E-UTRAN; hence the E-UTRAN architecture is said to be flat. The eNBs are normally interconnected with each other by an interface known as “X2” and to the EPC by an S1 interface. More specifically, to MME 404 by an S1-MME interface and to the SGW by an S1-U interface. The protocols that run between the eNBs and the UEs are generally referred to as the “AS protocols.” Details of the various interfaces are well known and not described herein.

The eNB 410 hosts the PHYsical (PHY), Medium Access Control (MAC), Radio Link Control (RLC), and Packet Data Control Protocol (PDCP) layers, which are not shown in FIG. 4, and which include the functionality of user-plane header-compression and encryption. The eNB 410 also provides Radio Resource Control (RRC) functionality corresponding to the control plane, and performs many functions including radio resource management, admission control, scheduling, enforcement of negotiated Up Link (UL) QoS, cell information broadcast, ciphering/deciphering of user and control plane data, and compression/decompression of DL/UL user plane packet headers.

The RRC layer in eNB 410 covers all functions related to the radio bearers, such as radio bearer control, radio admission control, radio mobility control, scheduling and dynamic allocation of resources to UEs in both uplink and downlink, source rate and PIT adaptation, header compression for efficient use of the radio interface, security of all data sent over the radio interface, and connectivity to the EPC. The RRC layer makes handover decisions based on neighbor cell measurements sent by UE 411, generates pages for UEs 411 over the air, broadcasts system information, controls UE measurement reporting, such as the periodicity of Channel Quality Information (CQI) reports, and allocates cell-level temporary identifiers to active UEs 411. The RRC layer also executes transfer of UE context from a source eNB to a target eNB during handover, and provides integrity protection for RRC messages. Additionally, the RRC layer is responsible for the setting up and maintenance of radio bearers.

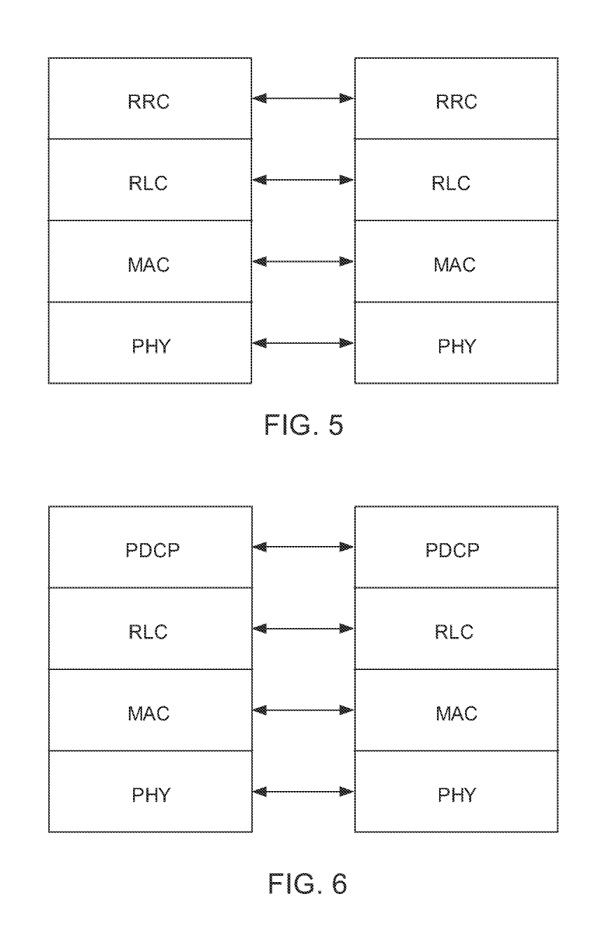

FIGS. 5 and 6 depict radio interface protocol structures between a UE and an eNodeB that are based on a 3GPP-type radio access network standard. More specifically, FIG. 5 depicts individual layers of a radio protocol control plane and FIG. 6 depicts individual layers of a radio protocol user plane. The protocol layers of FIGS. 5 and 6 can be classified into an L1 layer (first layer), an L2 layer (second layer) and an L3 layer (third layer) on the basis of the lower three layers of the OSI reference model widely known in communication systems.

The physical (PHY) layer, which is the first layer (L1), provides an information transfer service to an upper layer using a physical channel. The physical layer is connected to a Medium Access Control (MAC) layer, which is located above the physical layer, through a transport channel. Data is transferred between the MAC layer and the PHY layer through the transport channel. A transport channel is classified into a dedicated transport channel and a common transport channel according to whether or not the channel is shared. Data transfer between different physical layers, specifically between the respective physical layers of a transmitter and a receiver, is performed through the physical channel.

A variety of layers exist in the second layer (L2 layer). For example, the MAC layer maps various logical channels to various transport channels, and performs logical-channel multiplexing for mapping various logical channels to one transport channel. The MAC layer is connected to the Radio Link Control (RLC) layer serving as an upper layer through a logical channel. The logical channel can be classified into a control channel for transmitting information of a control plane and a traffic channel for transmitting information of a user plane according to categories of transmission information.

The RLC layer of the second layer (L2) performs segmentation and concatenation on data received from an upper layer, and adjusts the size of data to be suitable for a lower layer transmitting data to a radio interval. In order to guarantee various Qualities of Service (QoSs) requested by respective radio bearers (RBs), three operation modes, i.e., a Transparent Mode (TM), an Unacknowledged Mode (UM), and an Acknowledged Mode (AM), are provided. Specifically, an AM RLC performs a retransmission function using an Automatic Repeat and Request (ARQ) function so as to implement reliable data transmission.

A Packet Data Convergence Protocol (PDCP) layer of the second layer (L2) performs a header compression function to reduce the size of an IP packet header having relatively large and unnecessary control information in order to efficiently transmit IP packets, such as IPv4 or IPv6 packets in a radio interval with a narrow bandwidth. As a result, only information required for a header part of data can be transmitted, so that transmission efficiency of the radio interval can be increased. In addition, in an LTE-based system, the PDCP layer performs a security function that includes a ciphering function for preventing a third party from eavesdropping on data and an integrity protection function for preventing a third party from handling data.

A Radio Resource Control (RRC) layer located at the top of the third layer (L3) is defined only in the control plane and is responsible for control of logical, transport, and physical channels in association with configuration, re-configuration and release of Radio Bearers (RBs). The RB is a logical path that the first and second layers (L1 and L2) provide for data communication between the UE and the UTRAN. Generally, Radio Bearer (RB) configuration means that a radio protocol layer needed for providing a specific service, and channel characteristics are defined and their detailed parameters and operation methods are configured. The Radio Bearer (RB) is classified into a Signaling RB (SRB) and a Data RB (DRB). The SRB is used as a transmission passage of RRC messages in the C-plane, and the DRB is used as a transmission passage of user data in the U-plane.

A downlink transport channel for transmitting data from the network to the UE may be classified into a Broadcast Channel (BCH) for transmitting system information and a downlink Shared Channel (SCH) for transmitting user traffic or control messages. Traffic or control messages of a downlink multicast or broadcast service may be transmitted through a downlink SCH and may also be transmitted through a downlink multicast channel (MCH). Uplink transport channels for transmission of data from the UE to the network include a Random Access Channel (RACH) for transmission of initial control messages and an uplink SCH for transmission of user traffic or control messages.

Downlink physical channels for transmitting information transferred to a downlink transport channel to a radio interval between the UE and the network are classified into a Physical Broadcast Channel (PBCH) for transmitting BCH information, a Physical Multicast Channel (PMCH) for transmitting MCH information, a Physical Downlink Shared Channel (PDSCH) for transmitting downlink SCH information, and a Physical Downlink Control Channel (PDCCH) (also called a DL L1/L2 control channel) for transmitting control information, such as DL/UL Scheduling Grant information, received from first and second layers (L1 and L2). In the meantime, uplink physical channels for transmitting information transferred to an uplink transport channel to a radio interval between the UE and the network are classified into a Physical Uplink Shared Channel (PUSCH) for transmitting uplink SCH information, a Physical Random Access Channel for transmitting RACH information, and a Physical Uplink Control Channel (PUCCH) for transmitting control information, such as Hybrid Automatic Repeat Request (HARQ) ACK or NACK Scheduling Request (SR) and Channel Quality Indicator (CQI) report information, received from first and second layers (L1 and L2).

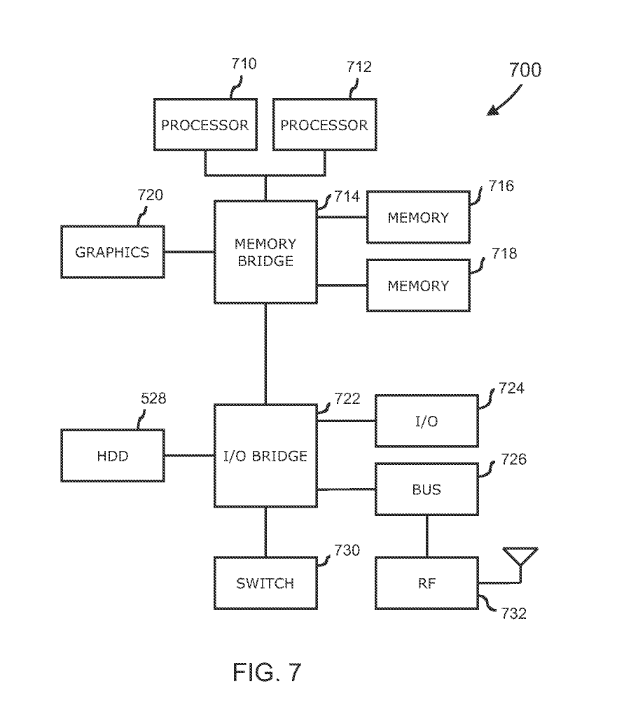

FIG. 7 depicts functional block diagram of an information-handling system 700 that is capable of performing source rate and PIT adaptation at an application layer according to the subject matter disclosed herein. Information-handling system 700 of FIG. 7 may tangibly embody one or more of any of the network elements of core network 400 as shown in and described with respect to FIG. 4. For example, information-handling system 700 may represent the hardware of eNB 410 and/or UE 411, with greater or fewer components depending on the hardware specifications of the particular device or network element. Although information-handling system 700 represents one example of several types of computing platforms, information-handling system 700 may include more or fewer elements and/or different arrangements of elements than shown in FIG. 7, and the scope of the claimed subject matter is not limited in these respects.

Information-handling system 700 may comprise one or more processors, such as processor 710 and/or processor 712, which may comprise one or more processing cores. One or more of processor 710 and/or processor 712 may couple to one or more memories 716 and/or 718 via memory bridge 714, which may be disposed external to processors 710 and/or 712, or alternatively at least partially disposed within one or more of processors 710 and/or 712. Memory 716 and/or memory 718 may comprise various types of semiconductor-based memory, for example, volatile-type memory and/or non-volatile-type memory. Memory bridge 714 may couple to a graphics system 720 (which may include a graphics processor (not shown) to drive a display device, such as a CRT, an LCD display, an LED display, touch-screen display, etc. (all not shown), coupled to information handling system 700.

Information-handling system 700 may further comprise input/output (I/O) bridge 722 to couple to various types of I/O systems, such as a keyboard (not shown), a display (not shown) and/or an audio output device (not shown), such as a speaker. I/O system 724 may comprise, for example, a universal serial bus (USB) type system, an IEEE-1394-type system, or the like, to couple one or more peripheral devices to information-handling system 700. Bus system 726 may comprise one or more bus systems, such as a peripheral component interconnect (PCI) express type bus or the like, to connect one or more peripheral devices to information-handling system 700. A hard disk drive (HDD) controller system 728 may couple one or more hard disk drives or the like to information handling system, for example, Serial ATA type drives or the like, or alternatively a semiconductor based drive comprising flash memory, phase change, and/or chalcogenide type memory or the like. Switch 730 may be utilized to couple one or more switched devices to I/O bridge 722, for example Gigabit Ethernet type devices or the like. Furthermore, as shown in FIG. 7, information-handling system 700 may include a radio-frequency (RF) block 732 comprising RF circuits and devices for wireless communication with other wireless communication devices and/or via wireless networks, such as core network 400 of FIG. 4, for example, in which information-handling system 700 embodies base station 414 and/or wireless device 416, although the scope of the claimed subject matter is not limited in this respect. In one or more embodiments, information-handling system could comprise an eNB and/or a UE that is capable of performing source rate and PIT adaptation at an application layer according to the subject matter disclosed herein.

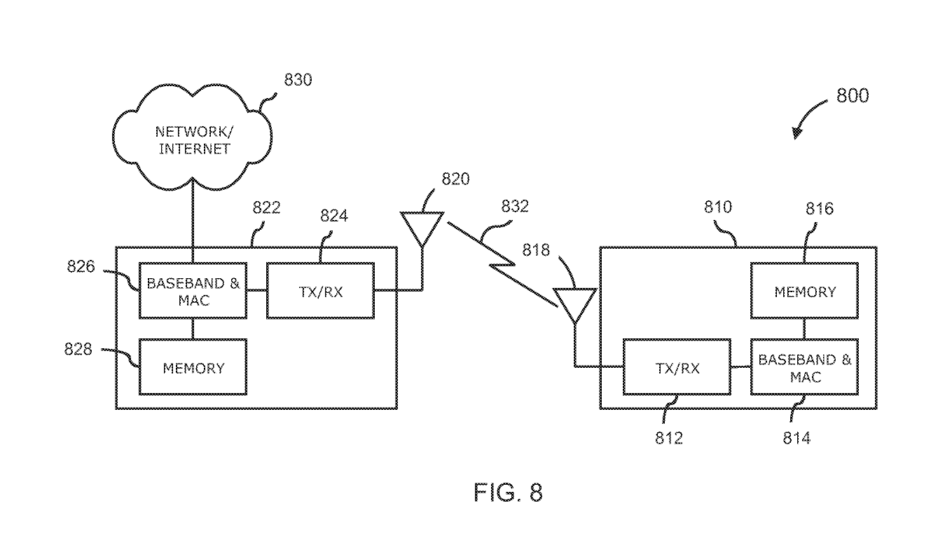

FIG. 8 depicts a functional block diagram of a wireless local area or cellular network communication system 800 depicting one or more network devices that are capable of performing source rate and PIT adaptation at an application layer according to the subject matter disclosed herein. In the communication system 800 shown in FIG. 8, a wireless device 810 may include a wireless transceiver 812 to couple to one or more antennas 818 and to a processor 814 to provide baseband and media access control (MAC) processing functions. In one or more embodiments, wireless device 810 may be a UE that provides source rate and PIT adaptation at an application layer, a cellular telephone, an information-handling system, such as a mobile personal computer or a personal digital assistant or the like, that incorporates a cellular telephone communication module, although the scope of the claimed subject matter is not limited in this respect. Processor 814 in one embodiment may comprise a single processor, or alternatively may comprise a baseband processor and an applications processor, although the scope of the claimed subject matter is not limited in this respect. Processor 814 may couple to a memory 816 that may include volatile memory, such as dynamic random-access memory (DRAM), non-volatile memory, such as flash memory, or alternatively may include other types of storage, such as a hard disk drive, although the scope of the claimed subject matter is not limited in this respect. Some portion or all of memory 816 may be included on the same integrated circuit as processor 814, or alternatively some portion or all of memory 816 may be disposed on an integrated circuit or other medium, for example, a hard disk drive, that is external to the integrated circuit of processor 814, although the scope of the claimed subject matter is not limited in this respect.

Wireless device 810 may communicate with access point 822 via wireless communication link 832, in which access point 822 may include at least one antenna 820, transceiver 824, processor 826, and memory 828. In one embodiment, access point 822 may be an eNB capable of performing source rate and PIT adaptation, a base station of a cellular telephone network, and in an alternative embodiment, access point 822 may be an access point or wireless router of a wireless local or personal area network, although the scope of the claimed subject matter is not limited in this respect. In an alternative embodiment, access point 822 and optionally mobile unit 810 may include two or more antennas, for example, to provide a spatial division multiple access (SDMA) system or a multiple-input-multiple-output (MIMO) system, although the scope of the claimed subject matter is not limited in this respect. Access point 822 may couple with network 830 so that mobile unit 810 may communicate with network 830, including devices coupled to network 830, by communicating with access point 822 via wireless communication link 832. Network 830 may include a public network, such as a telephone network or the Internet, or alternatively network 830 may include a private network, such as an intranet, or a combination of a public and a private network, although the scope of the claimed subject matter is not limited in this respect. Communication between mobile unit 810 and access point 822 may be implemented via a wireless local area network (WLAN), for example, a network compliant with a an Institute of Electrical and Electronics Engineers (IEEE) standard, such as IEEE 802.11a, IEEE 802.11b, HiperLAN-II, and so on, although the scope of the claimed subject matter is not limited in this respect. In another embodiment, communication between mobile unit 810 and access point 822 may be at least partially implemented via a cellular communication network compliant with a Third Generation Partnership Project (3GPP or 3G) standard, although the scope of the claimed subject matter is not limited in this respect. In one or more embodiments, antenna(s) 818 may be utilized in a wireless sensor network or a mesh network, although the scope of the claimed subject matter is not limited in this respect.

Although the claimed subject matter has been described with a certain degree of particularity, it should be recognized that elements thereof may be altered by persons skilled in the art without departing from the spirit and/or scope of claimed subject matter. The claimed subject matter will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. A device, comprising:
a Media Access Control (MAC) device capable of outputting information related to a congestion condition of a wireless link and information related to a Round Trip Time (RTT) of an end-to-end connection of the wireless link, the wireless link for communicating data generated by an application operating on the device, and the wireless link comprising a source rate of data generated by the application and a Packet Inter-arrival Time (PIT) for the data generated by the application; and
a rate controller capable of determining a source rate of the application or the PIT based on the information related to the congestion condition of the wireless link and the information related to the RTT of the end-to-end connection of the wireless link.

2. The device according to claim 1, wherein if the information related to the congestion condition indicates that a congestion condition exists, the rate controller changing the PIT of the data generated by the application from a first PIT to a second PIT, the second PIT being greater than the first PIT.

3. The device according to claim 2, wherein if the information related to the congestion condition continues to indicate that a congestion condition exists after the rate controller has changed the PIT of the data generated by the application from the first PIT to the second PIT, the rate controller changing the source rate of the data generated by the application from a first source rate to a second source rate, the second source rate being less than the first source rate.

4. The device according to claim 3, wherein if the information related to the congestion condition indicates that the congestion condition no longer exists after the rate controller has changed the PIT of the data generated by the application from the first PIT to the second PIT and the rate controller has changed the source rate of the data generated by the application from the first source rate to the second source rate, the rate controller changing the PTT of the data generated by the application from the second PIT to the first PIT before changing the second source rate to the first source rate.

5. The device according to claim 2, wherein if the information related to the congestion condition indicates that the congestion condition no longer exists after the rate controller has changed the PIT of the data generated by the application from the first PIT to the second PIT, the rate controller changing the PIT of the data generated by the application from the second PIT to the first PIT.

6. The device according to claim 1, wherein if the information related to the Round Trip Time (RTT) of the end-to-end connection of the wireless link, the rate controller changing the source rate of the data generated by the application from a first source rate to a second source rate, the second source rate being less than the first source rate.

7. The device according to claim 6, wherein if the information related to the congestion condition continues to indicate that a congestion condition exists after the rate controller has changed the source rate of the data generated by the application from the first source rate to the second source rate the rate controller changing the PIT of the data generated by the application from a first PIT to a second PIT, the second PIT being greater than the first PIT.

8. The device according to claim 7, wherein if the information related to the congestion condition indicates that the congestion condition no longer exists after the rate controller has changed the source rate of the data generated by the application from the first source rate to the second source rate and the rate controller has changed the PIT of the data generated by the application from the first PIT to the second PIT, the rate controller changing the PTT of the data generated by the application from the second PIT to the first PIT before changing the second source rate to the first source rate.

9. The device according to claim 6, wherein if the information related to the congestion condition indicates that the congestion condition no longer exists after the rate controller has changed the source rate of the data generated by the application from the first source rate to the second source rate, the rate controller changing the source rate of the data generated by the application from the second source rate to the first source rate.

10. The device according to claim 1, wherein the Media Access Control (MAC) device is further capable of outputting information related to channel quality (CQI) feedback information; geometry information of the device with respect to a base station that is part of the wireless link; sector loading information of a base station that is part of the wireless link; or an uplink transmit buffer-level status information, and
wherein the rate controller being further capable of determining the source rate of the application or the PIT based on the information related to channel quality (CQI) feedback information; geometry information of the device with respect to a base station that is part of the wireless link; sector loading information of a base station that is part of the wireless link; or an uplink transmit buffer-level status information.

11. The device according to claim 1, wherein the data generated by an application comprises voice-based data or video-based data.

12. The method, comprising:
receiving information related to a congestion condition of a wireless link and information related to a Round Trip Time (RTT) of an end-to-end connection of the wireless link, the wireless link for communicating data generated by an application operating on the device, and the wireless link comprising a source rate of data generated by the application and a Packet Inter-arrival Time (PIT) for the data generated by the application; and
determining a source rate of the application or the PIT based on the information related to the congestion condition of the wireless link and the information related to the RTT of the end-to-end connection of the wireless link by
changing the PIT of the data generated by the application from a first PIT to a second PIT if the information related to the congestion condition indicates that a congestion condition exists, the second PIT being greater than the first PIT, or
changing the source rate of the data generated by the application from a first source rate to a second source rate if the information related to the Round Trip Time (RTT) of the end-to-end connection of the wireless link, the second source rate being less than the first source rate.

13. The method according to claim 12, wherein if the information related to the congestion condition indicates that the congestion condition no longer exists after the PIT of the data generated by the application has been changed from the first PIT to the second PIT and the source rate of the data generated by the application has been changed from the first source rate to the second source rate, the PTT of the data generated by the application is changed from the second PIT to the first PIT before changing the second source rate to the first source rate.

14. The method according to claim 12, wherein if the information related to the congestion condition indicates that the congestion condition no longer exists after the PIT of the data generated by the application has been changed from the first PIT to the second PIT, the PIT of the data generated by the application is changed from the second PIT to the first PIT.

15. The method according to claim 12, wherein if the information related to the congestion condition indicates that the congestion condition no longer exists after the source rate of the data generated by the application has been changed from the first source rate to the second source rate and the PIT of the data generated by the application has been changed from the first PIT to the second PIT, the PTT of the data generated by the application is changed from the second PIT to the first PIT before the second source rate is changed to the first source rate.

16. The method according to claim 12, further comprising receiving information related to channel quality (CQI) feedback information; geometry information of the device with respect to a base station that is part of the wireless link; sector loading information of a base station that is part of the wireless link; or an uplink transmit buffer-level status information, and
determining the source rate of the application or the PIT further based on the information related to channel quality (CQI) feedback information; geometry information of the device with respect to a base station that is part of the wireless link; sector loading information of a base station that is part of the wireless link; or an uplink transmit buffer-level status information.

17. A device, comprising:
a Media Access Control (MAC) device capable of outputting information related to a congestion condition of a wireless link and information related to a Round Trip Time (RTT) of an end-to-end connection of the wireless link, the wireless link for communicating data generated by an application operating on the device, and the wireless link comprising a source rate of data generated by the application and a Packet Inter-arrival Time (PIT) for the data generated by the application;
a rate controller capable of determining a source rate of the application or the PIT based on the information related to the congestion condition of the wireless link and the information related to the RTT of the end-to-end connection of the wireless link by
changing the PIT of the data generated by the application from a first PIT to a second PIT if the information related to the congestion condition indicates that a congestion condition exists, the second PIT being greater than the first PIT, or
changing the source rate of the data generated by the application from a first source rate to a second source rate if the information related to the Round Trip Time (RTT) of the end-to-end connection of the wireless link, the second source rate being less than the first source rate; and
a transceiver coupled to the rate controller, the transceiver responsive to the rate controller by transmitting the data generated by the application at the source rate and the PIT determined by the rate controller.

18. The device according to claim 17, wherein the Media Access Control (MAC) device is further capable of outputting information related to channel quality (CQI) feedback information; geometry information of the device with respect to a base station that is part of the wireless link; sector loading information of a base station that is part of the wireless link; or an uplink transmit buffer-level status information, and
wherein the rate controller being further capable of determining the source rate of the application or the PIT based on the information related to channel quality (CQI) feedback information; geometry information of the device with respect to a base station that is part of the wireless link; sector loading information of a base station that is part of the wireless link; or an uplink transmit buffer-level status information.

19. The device according to claim 17, wherein the data generated by an application comprises voice-based data or video-based data.

20. The device according to claim 17, further comprising a display device capable of displaying at least a portion of the data generated by the application operating on the device, the display device comprising an LCD display, an LED display, or a touch-screen display.
